(19) United States
(12) Patent Application Publication
(10) Pub. No.: US 2025/0272455 A1
(43) Pub. Date: Aug. 28, 2025

(54) Method and Apparatus for Generating Training Data for Artificial Intelligence Model

(71) Applicants: Hyundai Motor Company, Seoul (KR); Kia Corporation, Seoul (KR)

(72) Inventor: Jae Hong Lee, Siheung-Si (KR)

(21) Appl. No.: 18/765,945

(22) Filed: Jul. 8, 2024

(30) Foreign Application Priority Data
Feb. 22, 2024 (KR) 10-2024-0025511

(51) Int. Cl. G06F 30/27; G06N 3/0895

(52) U.S. Cl. CPC G06F 30/27; G06N 3/0895

(57) ABSTRACT

A method of generating training data for an artificial intelligence model may comprise: providing metadata and ground truth data generated from original data; generating accumulated data obtained by accumulating training results less than or equal to a standard indicator target value by comparing artificial intelligence model training results with a target indicator based on the ground truth data; deriving an autonomous driving scenario using the accumulated data; and generating synthetic ground truth data for training the artificial intelligence model by performing a simulation according to the autonomous driving scenario.

### CROSS REFERENCE TO RELATED APPLICATION

The present application claims priority to Korean Patent Application No. 10-2024-0025511, filed on Feb. 22, 2024, the entire contents of which is incorporated herein for all purposes by reference.

### FIELD

The present disclosure relates to a method and apparatus for generating training data for an artificial intelligence model, and more particularly, to a method and apparatus for synthesizing training data for an artificial intelligence model that can secure training data by generating synthesized data through autonomous driving simulation.

### BACKGROUND

In order to develop autonomous driving technology for mobility apparatuses, data for various driving situations is required. However, there are technical limitations in acquiring data assuming all driving situations, and enormous economic costs are incurred to process the data acquired through this.

For example, in the past, when an artificial intelligence model determines that uncertainty about a specific example is high, the example was additionally labeled and selected as useful training data to improve the model's performance, or data was automatically labeled using predefined rules or the artificial intelligence model.

However, this only uses the secured data as input and classifies it as additional training data based on this, and is still limited in securing data for edge cases, which are exceptional or extreme situations that are difficult to obtain.

Accordingly, in order to improve the performance of artificial intelligence models for autonomous driving, a method for acquiring data that is essential but difficult to obtain is required.

In other words, in order to achieve autonomous driving goals and expand the operational design domain within the operation design domain (ODD), which defines an area to which the autonomous driving system is applicable, a method of securing data on edge cases is required.

### SUMMARY

The following summary presents a simplified summary of certain features. The summary is not an extensive overview and is not intended to identify key or critical elements.

Systems, apparatuses, and methods are described for generating training data for an artificial intelligence model for use in autonomous driving. A method may comprise receiving metadata and ground truth data generated, by an artificial intelligence model, from original data obtained from a sensor installed on a mobility apparatus; generating accumulated data by accumulating data based on a portion of the ground truth data that corresponds to training results, of the artificial intelligence model, that are determined to be less than or equal to a standard indicator target value; deriving an autonomous driving scenario based on the accumulated data; and generating synthetic ground truth data for training the artificial intelligence model by performing an autonomous driving simulation according to the autonomous driving scenario.

An apparatus may be configured for generating training data for an artificial intelligence model. The apparatus may comprise a memory configured to store at least one instruction and a processor configured to execute the at least one instruction stored in the memory based on data obtained from the memory. The at least one instruction, when executed by the processor, may configure the processor to: receive metadata and ground truth data generated, by an artificial intelligence model, from original data obtained from a sensor installed on a mobility apparatus; generate accumulated data by accumulating data based on a portion of the ground truth data that corresponds to training results, of the artificial intelligence model, that are determined to be less than or equal to a standard indicator target value; derive an autonomous driving scenario based on the accumulated data; and generate synthetic ground truth data for training the artificial intelligence model by performing an autonomous driving simulation according to the autonomous driving scenario.

These and other features and advantages are described in greater detail below.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a server communicating with another device to transmit and receive data;

FIG. 2 is a diagram showing modules constituting a mobility apparatus according to the present disclosure;

FIG. 3 is a diagram showing modules constituting a server;

FIG. 4 is a flowchart showing a process of generating training data for an artificial intelligence model according to the present disclosure;

FIG. 5 is a flowchart showing a process of generating accumulated data according to artificial intelligence model training results; and

FIG. 6 is a flowchart showing a process of generating synthetic ground truth data according to a simulation result based on a generated autonomous driving scenario.

### DETAILED DESCRIPTION

Hereinafter, examples of the present disclosure will be described in detail with reference to the accompanying drawings so that those skilled in the art may easily implement the present disclosure. However, the present disclosure may be implemented in various different ways, and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present invention and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, ““at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, examples of the present disclosure will be described with reference to the accompanying drawings.

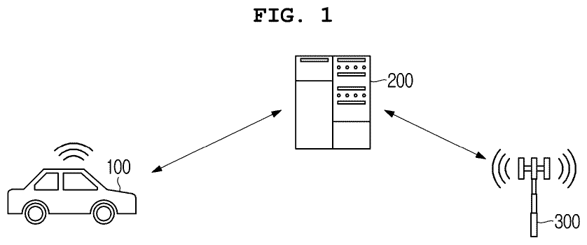

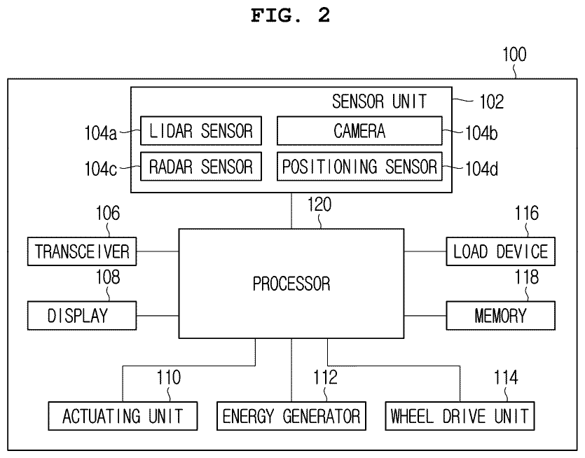

Hereinafter, mobility and server that implement a process of synthesizing training data for an artificial intelligence model will be described with reference to FIGS. 1 and 2.

FIG. 1 is a diagram illustrating a server communicating with another device to transmit and receive data.

Referring to FIG. 1, a mobility apparatus 100 may be driven based on electrical energy or fossil energy. In the case of electrical energy, the mobility apparatus 100 may, for example, adopt pure battery-based mobility driven only by a high-voltage battery or a gas-based fuel cell as an energy source. Additionally, fuel cells may utilize various types of gas that may generate electrical energy, and the gas may be, for example, hydrogen. However, it is not limited to this and various gases are applicable. In the case of fossil energy, the mobility apparatus 100 is driven based on fuel such as gasoline, diesel oil, or liquefied gas, and may be equipped with an engine that drives a wheel drive unit 114 by combustion of the fuel. An engine may be included in an energy generator 112 in terms of providing driving rotational force of the wheel to the wheel drive unit 114.

For convenience of description, in the present disclosure, the mobility apparatus 100 is described as being an electric energy-based mobility. However, except for regenerative braking, charging, discharging, etc. described in the present disclosure, examples of the present disclosure are also applicable to a fossil energy-based mobility.

The mobility apparatus 100 may refer to a mobile object that may physically move space. Specifically, the mobility apparatus 100 is a ground moving vehicle that runs on the ground, and may be a typical passenger vehicle, a commercial vehicle, a purpose-built vehicle (PBV), or the like. The mobility apparatus 100 may be a four-wheeled vehicle, such as a car, SUV, or light truck, or may be a vehicle with more than four wheels, such as a bus, large truck, container carrier, or heavy equipment vehicle. In addition, the mobility apparatus 100 may include an aerial means of transportation such as an airplane, a drone, or a helicopter, but is not limited thereto and may also include a means of transportation such as a ship or a submarine capable of moving on the sea.

The mobility apparatus 100 may be controlled and autonomously driven, and autonomous driving may be implemented as semi-autonomous driving or fully autonomous driving. Fully autonomous driving may be provided as autonomous movement in which the processor 120 of the mobility apparatus 100 takes full control without user intervention, even if the driving situation is uncertain. Semi-autonomous driving may be provided as autonomous movement that requires driver intervention depending on specific driving situations. Semi-autonomous driving may be implemented so that the processor 120 transfers control to the user while deactivating autonomous driving when the above situation occurs, allowing the user to perform manual driving. According to the levels of autonomous driving defined by the Society of Automotive Engineers (SAE), semi-autonomous driving may correspond to autonomous driving levels 1 to 4, and fully autonomous driving may correspond to level 5.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

Meanwhile, the mobility apparatus 100 may communicate with other devices 200 and 300 or with another mobility apparatus 400. The other devices include, for example, a server 200 that supports various control, status management, and driving of the mobility apparatus 100, an ITS device 300 for receiving information from an Intelligent Transportation System (ITS), and various types of user devices, etc. The server 200 is, for example, an external device operated by a mobility manufacturer or provided to service autonomous driving, and may receive connected data from the mobility apparatus 100 or transmit data necessary for autonomous driving. In order to support autonomous driving and various services of the mobility apparatus 100, the server 200 may transmit a software module and various information used to control the mobility apparatus to the mobility apparatus 100 in response to a request and data transmitted from the mobility apparatus 100 and the user device.

The ITS device 300 is, for example, a road side unit (RSU), and the ITS device 300 may mutually exchange mobility perception data, driving control and status data, and environmental data around mobility, map data, etc. through V2I with the mobility apparatus 100 to assist the user in driving their own vehicle or to support autonomous driving of the mobility apparatus 100. The mobility apparatus 100 may support its own vehicle driving or autonomous driving by mutually exchanging the data listed above through V2V with another mobility 400.

The mobility apparatus 100 may communicate with other mobility or other devices based on cellular communication, WAVE (Wireless Access in Vehicular Environment) communication, DSRC (Dedicated Short Range Communication) or short-range communication, or other communication methods.

For example, the mobility apparatus 100 may use a cellular communication network such as LTE, 5G communication network, WiFi communication network, WAVE communication network, etc. to communicate with the server 200, the ITS device 300, and the other mobility 400. As another example, DSRC, etc. used in the mobility apparatus 100 may be used for communication between mobilities. The communication method between the mobility apparatus 100, the server 200, the ITS device 300, the other mobility 400, and the user device is not limited to the above-described example.

Although not shown, the mobility apparatus 100 may receive captured image data from a photographing device fixed at a specific location or a mobile photographing device using the above-described communication unit. Likewise, the server 200 may also receive image data captured by the above-described photographing device.

FIG. 2 is a diagram showing modules constituting a mobility apparatus according to the present disclosure.

The mobility apparatus 100 may include a sensor unit 102, a transceiver 106, a display 108, an actuating unit 110, an energy generator 112, a wheel drive unit 114, a load device 116, and a memory 118 and a processor 120. Each component is not an essential component, and additional components may be included or the above-described components may be omitted, and one component may be included in or combined with another component to enable a single component to perform multiple functions.

The sensor unit 102 may be equipped with various types of detectors that detect various states and situations occurring in the external and internal environments of the mobility apparatus 100 and determine location information of the mobility apparatus 100. That is, the sensor unit 102 is composed of multiple sensor modules including heterogeneous sensors, and may obtain detected sensing data from each sensor.

Specifically, the sensor unit 102 includes a LiDAR sensor 104a, a camera 104b functioning as an image sensor, and a radar sensor 104c to recognize dynamic and static objects present around the mobility apparatus 100, and may have a positioning sensor 104d that acquires location information of mobility. The sensor unit 102 may acquire sensor data including 3D recognition data, perception observation data, and location data using the above-mentioned sensors. The sensor data may include information on intrinsic geometry and extrinsic geometry of the above-mentioned sensor, and the 3D recognition sensor corresponds to LiDAR data, and both terms may be used interchangeably below. The perception observation data may include camera image data and radar data.

The LiDAR sensor 104a may be a type of 3D recognition sensor according to the present disclosure, and hereinafter, the LiDAR sensor and 3D recognition sensor may be used interchangeably. The LiDAR sensor 104a may be a sensor that observes the surrounding environment and perceives the three-dimensional shape of an object based on laser scanning. Specifically, the LiDAR sensor 104a may acquire three-dimensional recognition data about the surrounding environment and object by scanning a laser around the mobility apparatus 100. The 3D recognition data may include a point cloud expressing the 3D shape of an object, that is, detection data, and observation image data that visually represents the surrounding environment. The detection data may be provided to identify each object by indicating, for example, the three-dimensional outline shape of the object and the arrangement of the object. The image data may be provided to identify the object and the surrounding environment, for example, through images of the object and the surrounding environment.

The camera 104b may acquire two-dimensional image data about the surrounding environment and object of the mobility apparatus 100, or image data with depth information. The camera 104b according to the present disclosure may include a monocular camera and may acquire the above-described image data. For example, the radar sensor 104c may irradiate radio waves of a predetermined wavelength to the surrounding area and detect behavior data about the behavior of the object based on the radio waves reflected from the object. The object's behavior data may include, for example, presence or absence of the object and the presence or absence of object movement, a distance between the mobility apparatus 100 and the object, the speed of the object, the direction of movement, etc.

The sensor unit 102 may include a gyro sensor, an acceleration sensor, a wheel sensor, an odometer, a speed sensor, etc. in addition to the positioning sensor 104d, to check its own position, driving posture, acceleration, speed, etc. Through this, sensor data such as speed, acceleration, steering, etc. may be obtained. In addition, the sensor unit 102 may have an internally oriented camera 104b, a biosensor for detecting bio signals of a driver and a passenger, and various detection modules for detecting operation and status of internal devices, in order to monitor the status of the user and the passenger inside the mobility apparatus 100 and the operating status of the mobility internal device that may be operated by the user.

In the present disclosure, only the sensors of the sensor unit 102 referred to in the description of the example are described, and may further include sensors that detect various situations not listed here.

The transceiver 112 may support mutual communication with the server 200, the ITS device 300, etc. In the present disclosure, original data generated using data generated or stored through the sensor unit 102 while driving may be transmitted to the server 200, and conversely, original data may be received from the server 200. In the present disclosure, the mobility apparatus 100 may transmit and receive data used in the method according to the present disclosure to and from the outside through the transceiver 116.

The display 108 may function as a user interface. The display 108 may display the operating state, control state, route/traffic information and remaining energy amount information of the mobility apparatus 100, and content requested by the driver, etc. by the processor 120. The display 108 is configured as a touchscreen capable of detecting driver input, and may receive a driver's request to instruct the processor 120.

The user may activate or deactivate the autonomous driving function through a soft-type interface such as a touch on the display 108 or a hard-type interface provided at a predetermined location inside the mobility apparatus 100. In the case of a hard-type interface, buttons or keys for autonomous driving functions may be installed on, for example, a steering wheel, dashboard, etc. Additionally, the interfaces may be configured to provide detailed options for the user to select various functions provided at the corresponding level of autonomous driving.

Meanwhile, the mobility apparatus 100 may include an actuating unit 110, an energy generator 112, a wheel drive unit 114, and a load device 116.

The actuating unit 110 includes at least one module that implements a driving operation and may perform at least one of longitudinal control such as acceleration and deceleration or lateral control such as steering. The actuating unit 110 may include pedals, a steering wheel, etc. that receive the user's request for control, as well as various operation modules for causing the wheel drive unit 114 to perform a driving operation according to the request.

The energy generator 112 may generate and supply power and electricity used in the driving power system such as the wheel drive unit 114 and the load device 114. When the mobility apparatus 100 is driven based on electrical energy, the energy generator 112 may be composed of, for example, an electric battery, or a combination of an electric battery and a fuel cell that charges the battery. In the case of the combination of the electric battery and the fuel cell, the energy generator 112 may include a tank that stores a material used to produce power for the fuel cell, such as hydrogen gas. When the mobility apparatus 100 is driven based on fossil energy, the energy generator 112 may be composed of an internal combustion engine.

The wheel drive unit 114 may include a plurality of wheels, a driving force transmission module for generating driving force and applying it to the wheels or transmitting the driving force, a braking module for slowing down the driving of the wheels, and a steering module for realizing lateral control of the wheels. When the mobility apparatus 100 is driven based on electrical energy, the driving force transmission module may be composed of a motor module that generates driving force based on power output from the electric battery. When the mobility apparatus 100 is operated based on fossil energy, the driving force transmission module may include a transmission that transmit power from an internal combustion engine, and a gear module.

The load device 116 is mounted on the mobility apparatus 100 and may be an auxiliary device that consumes power supplied from the energy generator 112 or converted from the output of the energy generator 112 by use by the passenger or user. In the present disclosure, the load device 116 may be a type of non-driving electric device excluding the driving power system such as the wheel drive unit 114. The load device 114 may be, for example, an air conditioning system, a lighting system, a seat system, and various devices installed in the mobility apparatus 100.

Additionally, the mobility apparatus 100 may include a memory 118 and a processor 120.

The memory 118 may store applications and various data for controlling the mobility apparatus 100 and load applications or read and write data according to a request from the processor 120. According to an example of the present disclosure, the memory 118 may store an application and at least one instruction for generating original data by processing sensor data obtained from various sensors included in the sensor unit 102 and image data.

The processor 120 may perform overall control of the vehicle 100. The processor 120 may be configured to execute the application and instruction stored in the memory 118. The processor 120 may activate autonomous driving in response to an autonomous driving request made by the user or the vehicle 100 itself, and control the vehicle 100 to activate autonomous driving at a level applied to the vehicle 100. In addition, the processor 120 may deactivate autonomous driving according to the user's request for disabling or automatic disabling and control the vehicle 100 to be driven manually.

In relation to the present disclosure, the processor 120 may generate original data by processing sensor data and image data using the application, instruction, and data stored in the memory 118.

In the present disclosure, the processor 120 may be implemented as a single processing module, for example. As another example, the processing may be performed in a plurality of processing modules, and the processor 120 may be collectively referred to as a plurality of processing modules in the present disclosure.

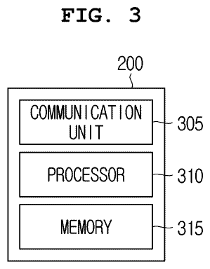

Hereinafter, a process of generating synthetic ground truth data in the server 200 according to an example of the present disclosure will be described with reference to FIG. 3.

The server 200 may include a communication unit 305, a processor 310, and a memory 315. Each component is not an essential component, and additional components may be included or the components may be omitted, and one component may be included in or combined with another component to enable a single component to perform multiple functions.

According to the present disclosure, the communication unit 305 may transmit and receive original data or transmit an artificial intelligence model that has been trained based on the received original data to the mobility apparatus 100, like the transceiver 106 of the mobility apparatus 100.

The processing of the processor 310 of the server 200 according to the present disclosure may be substantially the same as the processing of the processor 120 of the mobility apparatus 100 described above, and hereinafter, for convenience of description, the processing of the processor 310 of the server 200 will be focused upon. The memory 315 of the server 200 may store substantially the same application and instruction as the memory 118 of the mobility apparatus 100. The memory 315 of the server 200 may collect original data from the mobility apparatus 100 or other mobility, generate metadata and ground truth data from the collected original data, generate accumulated data obtained by accumulating training results less than or equal to a standard indicator target value by comparing an artificial intelligence model training result with a standard indicator based on the ground truth data, derive an autonomous driving scenario using the accumulated data, and store the application and at least one instruction for generating synthetic ground truth data for training the artificial intelligence model by performing a simulation according to the autonomous driving scenario.

The processor 310 may generate metadata and ground truth data from the collected original data, generate accumulated data obtained by accumulating training results less than or equal to a standard indicator target value by comparing artificial intelligence model training results with a standard indicator based on the ground truth data, derive an autonomous driving scenario using the accumulated data, and generate synthetic ground truth data for training the artificial intelligence model by performing a simulation according to the autonomous driving scenario. In addition, the ground truth data and the synthetic ground truth data may be divided according to a predetermined ratio to additionally configure data for training the artificial intelligence model. The artificial intelligence model according to the present disclosure may mean, for example, a CNN (Convolutional Neural Network) model that recognizes an object, but is not limited thereto and may include all artificial intelligence models that perform recognition, detection, and classification of the object.

In the present disclosure, the metadata may refer to location information, road information, time information, and environmental information for a specific scene of image data extracted from original data. For example, the location information may mean positioning information where a specific scene was captured. The road information may be marked on the road or may include infrastructure information in lane or road units. For example, it may include information such as speed limit signs, traffic signs, U-turns that guide the vehicle's driving direction, crosswalks, and stop lines. In addition, the road information may include information about attributes according to local driving on the road. For example, it may include the start and end point of a lane, left turn, right turn, straight, a type of lane such as general road, highway, etc., the start and end point of an intersection lane, the start and end point of an at-grade intersection, the start and end point of tunnel, bridge, overpass, etc., the start and end point of variable lanes, U-turn signs for specific lanes, traffic lights and signs for each lane, lane connections, crosswalks, stop lines, traffic light locations, topography around the road, facility information such as bus stops and taxi ranks, information on lane conditions such as lanes under construction or closed. In addition, it may include the detailed information of the road, such as upper and lower lane distinction, road expansion or reduction type and start and end point, IC/JC junction, bridge start and end point, tunnel start and end point, bridge, overpass or traffic rules, safety facilities, administration boundaries, junctions, etc., but is not limited thereto, and may include all road-related information that may be implemented through an autonomous driving scenario simulation, which will be described later. The time information may include information about a time at which a specific scene was captured, and may include, for example, not only information in time units such as precise hours, minutes, and seconds, but also information in time units obtained by dividing daily times such as day, evening, and night according to specific standards. The environmental information may include all data used to perceive and interpret the surrounding environment. For example, it may include weather information such as snow, rain, fog and visibility, and road environmental information such as road pavement conditions and road surface conditions, and is not limited to this.

The ground truth data may be divided into training data for training the artificial intelligence model and evaluation data for evaluating the artificial intelligence model. The training data and the evaluation data may be automatically classified by an algorithm and configured in the same format as the ground truth data. For example, the dataset of the original data may be classified into training data and evaluation data at a ratio of 7:3. An optimal or set composition ratio may vary depending on the size and characteristics of the dataset of the original data and the task of the artificial intelligence model.

Hereinafter, a process of generating training data for an artificial intelligence model will be described, focusing on the processing of the processor 310 of the server 200.

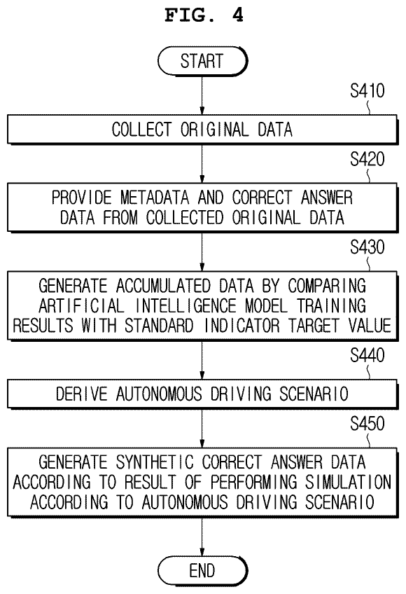

FIG. 4 is a flowchart showing a process of generating training data for an artificial intelligence model according to the present disclosure.

The server 200 may control the communication unit 305 through the processor 310 and collects original data obtained by processing sensor data obtained by the sensor unit 102 and image data from the mobility apparatus 100 (S410). As another example, the server 200 may collect sensor data and image data and process them into original data. As an example, the server 200 may receive original data including information on extrinsic geometry such as the model, mounting position, camera direction, and viewing angle of the camera 104b, which is a sensor mounted on the mobility apparatus 100, and information on intrinsic geometry such as focal length, sensor size, lens distortion, etc., but is not limited thereto, and may receive original data including all information about the sensors included in the sensor unit 102. In addition, the server 200 may receive original data including three-dimensional recognition data such as the position, size, and depth of the object, object behavior data such as speed, acceleration, driving direction, and distance, image data acquired from the camera 104b, information on a location where image data is captured, road information, time information, and environmental information.

The server 200 may provide metadata and ground truth data from the collected original data (S420). The server 200 may provide metadata and ground truth data through curation and labeling. Curation and labeling may be performed by an auto-curation and auto-labeling algorithm provided by the server 200, and/or may be assigned by the user. Specifically, the metadata may refer to location information, road information, time information, and/or environmental information of a specific scene of image data included in the original data, and/or may refer to information that creates an environment for deriving autonomous driving scenarios. The specific scene may mean a unit of frame for deriving an autonomous driving scenario. For example, the specific scene may represent a continuous driving process in which the mobility apparatus 100 changes lanes from a first lane to a second lane.

The ground truth data may be divided into training data for training the artificial intelligence model and evaluation data for evaluating the artificial intelligence model. The training data and the evaluation data may be automatically classified by an algorithm and configured in the same format as the ground truth data. An optimal and/or desired/selected composition ratio may vary depending on the size and characteristics of the dataset of the original data and the task of the artificial intelligence model. The training data may be used to train an artificial intelligence model, and the weight of the artificial intelligence model may be adjusted based on the training data. The evaluation data may be used to evaluate and adjust the performance of the artificial intelligence model being trained, and through this, the generalization performance of the model may be evaluated and hyperparameters may be adjusted. A standard indicator may be used to evaluate the training results of the artificial intelligence model, and at least one standard indicator may be set according to the target task of the artificial intelligence model. This will be described later.

Next, the server 200 may train the artificial intelligence model using the training data and evaluates the performance of the artificial intelligence model through the evaluation data. Next, the server 200 may generate accumulated data by comparing the artificial intelligence model training results with the standard indicator target value (S430).

Specifically, the server 200 may use a standard indicator such as a key performance indicator (KPI) as a tool for evaluating an artificial intelligence model. According to an example of the present disclosure, in the case of an object recognition task, standard indicators such as intersection over union (IOU), mean average precision (MAP), and location accuracy using Euclidean distance L2 may be used. IOU refers to a ratio that measures a ratio of the overlapping area between a bounding box indicating the area of a recognized object and an actual bounding box. For example, when using IOU as a standard indicator, if the IOU value of the recognized object is less than or equal to a standard indicator target value, the ground truth data for the object may be accumulated to generate accumulated data. In addition, when using IOU as a standard indicator, MAP may be preemptively considered as a standard indicator to generate the accumulated data. The MAP standard indicator refers to prediction accuracy for class such as the type of object. Specifically, it may be calculated based on a relationship between precision determined according to a match ratio between the result of predicting the class of the detected object and the ground truth data for the class of the detected object, and recall determined according to a match ratio between the result of predicting the class of the detected object and the ground truth data of the object to be detected. For example, if the accumulated data is generated using IOU and MAP as standard indicators, even if the IOU value is greater than or equal to a target value, if the MAP value is less than or equal to a target value, the server 200 may accumulate the ground truth data for the object and generate the accumulated data. Likewise, in generating the accumulated data, if any one of the above-mentioned standard indicators is less than or equal to the target value in consideration of not only the IOU and MAP but also Euclidean distance, the ground truth data for the corresponding object may be accumulated to generate the accumulated data.

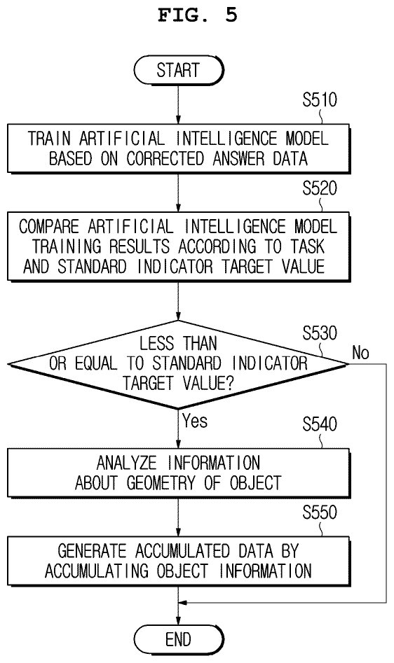

The accumulated data may be data separately extracted from the ground truth data for objects that showed task performance less than or equal to the standard indicator target value according to the task of the artificial intelligence model, and the data format included may be substantially the same as the ground truth data. For example, in the case of an object recognition task, if the IOU value of a pedestrian is less than or equal to the standard indicator target value, the server 200 may accumulate sensor data of the object such as the pedestrian's distance, size, and/or location, and object information of the class of the object such as pedestrian and car, and generate accumulated data. The specific process for this will be explained with reference to FIG. 5.

Next, the server 200 derives an autonomous driving scenario using the accumulated data (S440). Through this, it may be possible to secure training data to train the artificial intelligence model. In addition, by securing data on edge cases, which are exceptional or extreme situations that are difficult to obtain, the operational design area of autonomous driving mobility may be expanded through the secured training data.

Specifically, the server 200 may use accumulated data, original data, and metadata to derive/determine the autonomous driving scenario to be simulated. As an example, the server 200 may set a mobility apparatus sensor to be subjected to an autonomous driving scenario simulation based on information on extrinsic or intrinsic geometry of the sensor among the sensor data included in the original data. The surrounding road environment of the scenario to be simulated may be constructed (e.g., simulated/a simulation and/or representative data may be generated) using accumulated data, which is a set of ground truth data of the object that showed training results less than or equal to the standard indicator target value. Next, the server 200 may construct a simulation implementation environment using the metadata. A process of generating an autonomous driving scenario simulation will be described with reference to 6.

The server 200 may generate synthetic ground truth data according to the result of performing the simulation according to the generated autonomous driving scenario (S450). The synthetic ground truth data may include information for training the artificial intelligence model and/or may include data in the same format as the ground truth data (ground truth data based on original data/non-simulated data). For example, the synthetic ground truth data may include synthetic sensor data including information, about sensors, generated as the simulation is performed and/or synthetic image or other sensor data. The server may additionally or alternatively configure training data and/or evaluation data to train the artificial intelligence model using the generated synthetic ground truth data and existing ground truth data. The server 200 may augment training data through the above-described process and secure training data for the edge case that is difficult to obtain according to actual local driving of the mobility apparatus 100.

The server 200 may merge the synthetic ground truth data and the existing ground truth data to form ground truth data for training the artificial intelligence model according to a certain ratio. For example, the ratio of existing ground truth data and synthetic ground truth data may be configured at a ratio of 7:3, but is not limited to this, and the optimal configuration ratio may vary depending on the task of the artificial intelligence model.

Hereinafter, a process of generating accumulated data by the server 200 will be described in detail with reference to FIG. 5.

FIG. 5 is a flowchart showing a process of generating accumulated data according to artificial intelligence model training results.

The server 200 may train an artificial intelligence model based on ground truth data (S510). Specifically, the server 200 may train an artificial intelligence model using training data classified from the ground truth data and evaluates the trained artificial intelligence model through evaluation data.

Specifically, the server 200 may compare the artificial intelligence model training results according to a task and a standard indicator target value using the evaluation data in order to extract an object for artificial intelligence model evaluation and additional training (S520).

The server 200 may use a standard indicator as a key performance indicator as an evaluation tool, and the standard indicator may differ depending on the task. According to one example of the present disclosure, the server 200 may use any one of IOU, MAP, or Euclidean distance to evaluate an artificial intelligence model that performs the task of object recognition.

The server 200 may input evaluation data into the artificial intelligence model to evaluate object recognition task performance according to an example of the present disclosure and may compare the artificial intelligence model training results, ground truth data, and standard indicator. The standard indicator target value may be preset and/or may differ between tasks. For example, when using IOU as a standard indicator, the server 200 may measure a ratio of an overlapping area between a bounding box of the object recognized according to the evaluation data input and a bounding box of the object included in the ground truth data.

The server 200 may determine whether the IOU value is less than or equal to the standard indicator target value (S530). The server 200 may extract and/or store/accumulate only information about an object whose IOU value is less than or equal to the standard indicator target value.

The server 200 may analyze information about the geometry of the object whose IOU value is less than or equal to the standard index target value (S540). Information about the geometry of object information may refer to sensor data such as the distance, size, and/or location of the object.

Specifically, the server 200 may calculate a distribution of information about the object's geometry and/or specify representative information of the distribution. As an example, in order to generate an autonomous driving scenario, the server 200 may specify an average value of the distribution of a distance from a pedestrian, the size, location, and speed of the pedestrian as representative information, and specify an object based on that information. For example, the server 200 may obtain an average value such as of the height and/or movement speed of the pedestrian who showed a recognition rate less than or equal to the standard index target value, and an average value of a relative position distribution with their own vehicle. The average value of the height and/or movement speed of the pedestrian may be used to form such a pedestrian as an object on the autonomous driving scenario. To obtain the average value of the relative position distribution, the frequency of object recognition according to the position of the object on the coordinates, etc. may be considered. In other words, the frequency is weighted to the coordinates where the object that showed a recognition rate less than or equal to the standard index target value stayed, the average thereof is calculated, and the calculated coordinates of the object may be used as the relative position with their own vehicle to form an object in the autonomous driving scenario.

The method of specifying information representing the distribution of information about the geometry of the object is not limited to the above-described examples, and may use a median value, a mode, a maximum value, etc., and may differ depending on system settings. Likewise, at least one standard indicator may be set according to the task of the artificial intelligence model.

Next, the server 200 may generate accumulated data by accumulating object information including the information analysis result of the geometry of the object and the object's class (S550).

The accumulated data may include all information about ground truth data for accumulated objects in order to generate the autonomous driving scenario and implement it through a simulation. For example, it may include all LiDAR data, image data, and perception observation data of the object.

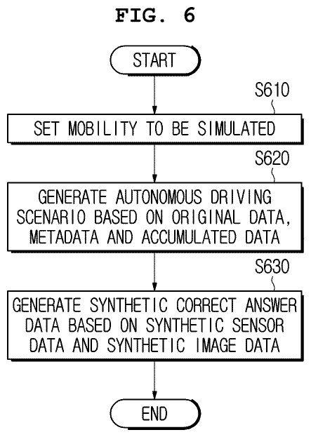

Hereinafter, a process of generating an autonomous driving scenario based on accumulated data and generating synthetic ground truth data to further train an artificial intelligence model through a simulation will be described with respect to FIG. 6.

FIG. 6 is a flowchart showing a process of generating synthetic ground truth data according to a simulation result based on a generated autonomous driving scenario.

The server 200 may set a scenario to be simulated based on the accumulated data (S610). Specifically, the server 200 may set a mobility apparatus sensor and/or mobility apparatus to be subjected to the autonomous driving scenario based on information such as intrinsic geometry or extrinsic geometry for the sensor mounted on the mobility apparatus 100 among the sensor data included in the original data. For example, information about the model, mounting location, direction, viewing angle, focal length, sensor size, lens distortion, etc., of the camera 104b may be set. Also, or alternatively, sensor performance of the mobility apparatus sensor to be simulated may be defined based on performance of the LiDAR sensor 104a, the radar sensor 104c, etc. In addition, or alternatively, depending on user input, information about the performance of the above-mentioned sensor may change. For example, the model of the camera 104b may be changed or the mounting position may be arbitrarily set (e.g., by user input). Likewise, the detection distance of the LiDAR sensor 104a and/or the radar sensor 104c may be changed.

In addition, the server 200 may set the mobility apparatus sensor to be simulated based on the model of the mobility apparatus 100, such as information on a car, large bus, or truck, and the geometric information of the model, such as length, width, height, etc., from the original data.

The server 200 may set not only the sensor of the mobility to be simulated, but also an initial state. For example, the state of the mobility apparatus sensor to be simulated may be set based on the speed, acceleration, and location information of the mobility apparatus 100 relative to the original data. As an example, the state to be simulated may be set to attempting to change the lane at 50 kph. Likewise, the state, such as the geometry and speed of the mobility apparatus sensor to be simulated, may be changed according to user input.

Next, the server 200 may generate an autonomous driving scenario based on the original data, metadata, and accumulated data (S620).

Specifically, the accumulated data may be used to construct the surrounding road environment of the mobility to be simulated. For example, an environment where a 130 cm tall pedestrian is stationary 50 m ahead may be constructed (e.g., generated, simulated). In constructing the surrounding road environment of the scenario to be simulated, information about the object around the mobility apparatus 100 from the original data may be used. For example, an object such as an additional mobility apparatus may be inserted between a pedestrian, which is an object that showed a training result less than or equal to the standard indicator target value from accumulated data, and the scenario/object/obstacle to be simulated (e.g., multiple scenarios/obstacles may be combined). Through this, complex autonomous driving situations may be implemented for generating training data for edge cases.

Additionally, the server 200 may construct a simulation implementation environment using metadata. Specifically, a specific environment may be constructed in relation to the initial state of the mobility to be simulated. For example, when the scenario to be simulated is attempting to change lanes, road information may be used to construct an environment in which the vehicle changes from the third lane to the second lane among four round-trip lanes. Additionally, or alternatively, in constructing the surrounding road environment, objects such as signs, street lights, and speed cameras may be inserted. In addition, the specific location of the scenario to be simulated, such as an intersection or highway, may be set. In addition, a simulation implementation environment may be constructed using time information such as night or day, road information such as paved roads, and environmental information such as snow, rain, or fog.

Next, the server 200 may simulate the autonomous driving scenario and may generate synthetic ground truth data based on synthetic sensor data and synthetic image data according to the simulation results (S630).

The synthetic sensor data may refer to sensor data generated by the sensor set (e.g., selected/determined) in the scenario to be simulated during the process of performing simulation, and may be substantially the same as sensor data acquired according to actual local driving. Likewise, the synthetic image data may refer to data acquired by a camera mounted on the mobility to be simulated among sensor data generated in the process of performing simulation. If the autonomous driving scenario simulation is performed only through data processing without generating separate images or videos, the server 200 may separately image the processed data to generate synthetic image data. In addition, images or videos generated by visualizing the autonomous driving scenario and performing the simulation may be used as synthetic image data.

That is, according to the present disclosure, the server 200 may generate synthetic ground truth data based on the synthetic sensor data and/or synthetic image data of the object to learn about autonomous driving situations that are difficult to obtain based on actual local driving, for additional learning of the object which showed an object recognition rate less than or equal to the standard indicator target vale, as the artificial intelligence model training results.

The synthetic ground truth data may be generated in substantially the same way as the ground truth data generated from original data to train the artificial intelligence model. That is, the server 200 may generate synthetic ground truth data by curating and labeling synthetic data including the synthetic sensor data and/or synthetic image data.

In addition, or alternatively, the server 200 may configure data for training the artificial intelligence model by dividing the ground truth data and the generated synthetic ground truth data according to a predetermined ratio. A predetermined composition ratio may be preset and/or may be changed according to user settings. Additionally, or alternatively, an optimal composition ratio may be calculated based on the training results of the artificial intelligence model. In calculating the ratio of ground truth data and synthetic ground truth data, standard indicators according to the task of the artificial intelligence model may be used. As an example, the server 200 may configure the ratio of existing ground truth data and synthetic ground truth data at a ratio of 7:3. The present disclosure is not so limited; the optimal composition ratio may vary depending on the task of the artificial intelligence model.

An object of the present disclosure is to provide a method and apparatus for generating training data for an artificial intelligence model that can secure training data by generating synthesized data through autonomous driving simulation.

According to the present disclosure, there is provided a method of generating training data for an artificial intelligence model, the method may comprising: providing metadata and ground truth data generated from original data; generating accumulated data obtained by accumulating training results less than or equal to a standard indicator target value by comparing artificial intelligence model training results with a target indicator based on the ground truth data; deriving an autonomous driving scenario using the accumulated data; and generating synthetic ground truth data for training the artificial intelligence model by performing a simulation according to the autonomous driving scenario.

According to another example of the present disclosure, there is provided an apparatus for generating training data for an artificial intelligence model, the apparatus may comprise: a memory configured to store at least one instruction; and a processor configured to execute the at least one instruction stored in the memory based on data obtained from the memory,
wherein the processor is configured to: provide metadata and ground truth data generated from original data; generate accumulated data obtained by accumulating training results less than or equal to a standard indicator target value by comparing artificial intelligence model training results with a target indicator based on the ground truth data; derive an autonomous driving scenario using the accumulated data; and generate synthetic ground truth data for training the artificial intelligence model by performing a simulation according to the autonomous driving scenario.

According to the example of the present disclosure in the method, the original data may comprise sensor data, image data and behavior data of a mobility apparatus.

According to the example of the present disclosure in the method, the metadata may comprise location information, road information and environmental information collected from the original data.

According to the example of the present disclosure in the method, the standard indicator is may an indicator for task performance where at least one reference indicator is able to be set according to a task of the artificial intelligence model.

According to the example of the present disclosure in the method, the generating the accumulated data may comprises accumulating object information of a class of an object, when the artificial intelligence model training results according to the task for the object included in the ground truth data are less than or equal to the standard indicator target value.

According to the example of the present disclosure in the method, the accumulating the object information may comprises calculating a distribution of information on geometry of the object and specifying representative information of the distribution.

According to the example of the present disclosure in the method, the deriving the autonomous driving scenario may comprises configuring data for setting the autonomous driving scenario based on the original data, the metadata and the accumulated data.

According to the example of the present disclosure in the method, the configuring the data for setting the autonomous driving scenario may comprises setting mobility apparatus sensor data to be simulated, which is composed of intrinsic and extrinsic geometry information of a sensor among the sensor data of the original data.

According to the example of the present disclosure in the method, the generating the synthetic ground truth data may comprises generating the synthetic ground truth data based on synthetic sensor data and synthetic image data in a process of performing the simulation.

According to the example of the present disclosure in the method, may further comprising configuring data for training the artificial intelligence model by dividing the ground truth data and the synthetic ground truth data according to a predetermined composition ratio.

The features briefly summarized above for this disclosure are only exemplary aspects of the detailed description of the disclosure which follow, and are not intended to limit the scope of the disclosure.

The technical problems solved by the present disclosure are not limited to the above technical problems and other technical problems which are not described herein will be clearly understood by a person having ordinary skill in the technical field (i.e., ordinary technician), to which the present disclosure belongs, from the present description.

According to the present disclosure, it is possible to provide a method and apparatus for generating training data for an artificial intelligence model that can secure training data by generating synthesized data through autonomous driving simulation.

Additionally, according to the present disclosure, it is possible to secure training data for training an artificial intelligence model related to autonomous driving image recognition technology.

Additionally, according to the present disclosure, it is possible to secure data on edge cases, which are exceptional or extreme situations that are difficult to obtain.

Additionally, according to the present disclosure, it is possible to expand the operational design area of autonomous driving mobility through the secured training data.

It will be appreciated by persons skilled in the art that that the effects that can be achieved through the present disclosure are not limited to what has been particularly described hereinabove.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative aspects of the present disclosure, and the matters described in the various examples may be applied independently or in combination of two or more.

In addition, various examples of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method comprising:
receiving metadata and ground truth data generated from original data obtained from a sensor installed on a mobility apparatus;
generating accumulated data by accumulating data based on a portion of the ground truth data that corresponds to training results, of the artificial intelligence model, that are determined to be less than or equal to a standard indicator target value
deriving an autonomous driving scenario based on the accumulated data; and
generating synthetic ground truth data for training the artificial intelligence model by performing an autonomous driving simulation according to the autonomous driving scenario.

2. The method of claim 1, wherein the original data comprises sensor data, image data and behavior data of the mobility apparatus.

3. The method of claim 1, wherein the metadata comprises location information, road information and environmental information associated with the original data.

4. The method of claim 1, wherein the standard indicator target value is a target value of an indicator for task performance of a task configured to be performed by the artificial intelligence model.

5. The method of claim 1, wherein the generating the accumulated data comprises:
based the training results, determined to be less than or equal to the standard indicator target value, comprising training results for a task for an object included in the ground truth data, accumulating object information for a class of the object.

6. The method of claim 5, wherein the accumulating the object information comprises determining a distribution of information about geometry of the object, wherein the object information comprises representative information of the distribution.

7. The method of claim 1, wherein the deriving the autonomous driving scenario comprises configuring data, for setting the autonomous driving scenario, based on the original data, the metadata and the accumulated data.

8. The method of claim 7, wherein the configuring the data comprises setting information about mobility of a sensor to be simulated, wherein the information about mobility of the sensor comprises intrinsic and extrinsic geometry information, of the sensor, associated with the original data.

9. The method of claim 1, wherein the generating the synthetic ground truth data comprises generating, based on synthetic sensor data and synthetic image data generated via the simulation, the synthetic.

10. The method of claim 1, further comprising configuring data for training the artificial intelligence model by selecting a first amount of the ground truth data and a second amount of the synthetic ground truth data according to a predetermined composition ratio of the first amount to the second amount.

11. An apparatus for generating training data for an artificial intelligence model, the apparatus comprising:
a memory configured to store at least one instruction; and
a processor configured to execute the at least one instruction stored in the memory based on data obtained from the memory, wherein the at least one instruction, when executed by the processor, configures the processor to:
receive metadata and ground truth data generated from original data obtained from a sensor installed on a mobility apparatus;
generate accumulated data by accumulating data based on a portion of the ground truth data that corresponds to training results, of the artificial intelligence model, that are determined to be less than or equal to a standard indicator target value;
derive an autonomous driving scenario based on the accumulated data; and
generate synthetic ground truth data for training the artificial intelligence model by performing an autonomous driving simulation according to the autonomous driving scenario.

12. The apparatus of claim 11, wherein the original data comprises sensor data, image data and behavior data of the mobility apparatus.

13. The apparatus of claim 11, wherein the metadata comprises location information, road information and environmental information associated with the original data.

14. The apparatus of claim 11, wherein the standard indicator target value is a target value of an indicator for task performance of a task configured to be performed by the artificial intelligence model.

15. The apparatus of claim 11, wherein the at least one instruction, when executed by the processor, configure the processor to:
based the training results, determined to be less than or equal to the standard indicator target value, comprising training results for a task for an object included in the ground truth data, accumulate object information for a class of the object.

16. The apparatus of claim 15, wherein the at least one instruction, when executed by the processor, configure the processor to accumulate the object information by determining a distribution of information about geometry of the object, wherein the object information comprises representative information of the distribution.

17. The apparatus of claim 11, wherein the at least one instruction, when executed by the processor, configure the processor to derive the autonomous driving scenario by configuring data, for setting the autonomous driving scenario, based on the original data, the metadata and the accumulated data.

18. The apparatus of claim 17, wherein the at least one instruction, when executed by the processor, configure the processor to configure the data by setting information about mobility of a sensor to be simulated, wherein the information about mobility of the sensor comprises intrinsic and extrinsic geometry information, of the sensor, associated with the original data.

19. The apparatus of claim 11, wherein the at least one instruction, when executed by the processor, configure the processor to generate, based on synthetic sensor data and synthetic image data generated via the simulation, the synthetic.

20. The apparatus of claim 11, whether the at least one instruction, when executed by the processor, configure the processor to configure data for training the artificial intelligence model by selecting a first amount of the ground truth data and a second amount of the synthetic ground truth data according to a predetermined composition ratio of the first amount to the second amount.
